(19) United States
(12) Patent Application Publication
(10) Pub. No.: US 2004/0089089 A1
(43) Pub. Date: May 13, 2004

(54) Anti-backlash method and system for multiple mesh gear train

(76) Inventors: Carlos J. Stevens, Peoria, AZ (US); Robert E. Winkel, Phoenix, AZ (US)

Correspondence Address: HONEYWELL INTERNATIONAL, INC., Law Dept. AB2, P.O. Box 2245, Morristown, NJ, 07962-9806, US

(21) Appl. No.: 10/290,653

(22) Filed: Nov. 8, 2002

(51) Int. Cl. F16H 55/18

(52) U.S. Cl. 74/440

(57) ABSTRACT

In a gear train having a first gear, a second gear in mesh with the first gear, and a third gear in mesh with the second gear, an anti-backlash mechanism having a first anti-backlash gear positioned in operative relationship with the first gear and the second gear, a second anti-backlash gear positioned in operative relationship with the second gear and the third gear, whereby the first anti-backlash gear controls backlash between the first gear and the second gear, and the second anti-backlash gear controls backlash between the second gear and the third gear.

Additionally, in a gear train having a first gear, a second gear in mesh with the first gear, and a third gear in mesh with the second gear, a method for reducing backlash comprising providing a first anti-backlash gear positioned in operative relationship with the first gear and the second gear, and providing a second anti-backlash gear positioned in operative relationship with the second gear and the third gear, whereby the first anti-backlash gear controls backlash between the first gear and the second gear, and the second anti-backlash gear controls backlash between the second gear and the third gear.

### TECHNICAL FIELD

The present invention relates to an anti-backlash gear system, and more particularly to an anti-backlash gear system used in a gear train with multiple meshes.

### BACKGROUND OF THE INVENTION

In a single gear mesh consisting of two mating gears there typically is a necessary operating clearance between the teeth due to manufacturing tolerances, radial play in the gear support bearings, incorrect center-to-center spacing of the gears, temperature variations and the like. This excess clearance results in backlash between the gears, such that if the gears are rotated in one direction, stopped, and then rotated in the opposite direction, the clearance must be taken up before the gear teeth come into contact with each other. In some cases it is desirable for backlash to be reduced or eliminated in the gear train to improve noise performance and angular position accuracy. Zero or near zero backlash is critical in gear trains requiring high angular precision and accuracy, for example, in antenna positioning systems and gimbals, optical positioning systems, and other commercial positioning systems. Anti-backlash gearing is usually accomplished by employing an anti-backlash gear set. An anti-backlash gear set consists of two gears capable of at least limited independent rotary motion which reside on a common axis. Of these two gears the gear which carries the primary and anti-backlash load is the primary gear, the second gear or anti-backlash carries only the anti-backlash load. The anti-backlash gear must have the same pitch diameter as the primary gear. A mechanism is used to preload the gears relative to one another by a displacement of a spring element, resulting in a tooth load reacted between the contacting teeth of the anti-backlash gear, the primary gear and the mating gear, resulting in zero backlash with tooth loads below the preload level.

This anti-backlash gear set can be used in a gearing system that does not require that the anti-backlash gear set in the train mesh with more than one other gear, i.e., for gearing systems having a single mesh. In those systems where the anti-backlash gear set must mesh with two or more gears, for example in a simple epicyclic gear train in which a planet gear must mesh with both the pinion gear and the internal ring gear, the anti-backlash scheme noted above is ineffective. This is true because backlash will only be removed from the mesh consisting of the gear with the largest tooth thickness and therefore will not act on any of the other gears in mesh. This results in the problem of utilizing a single anti-backlash gear set for two meshes. It would be desirable, therefore to have an anti-backlash mechanism for gear trains having multiple meshes.

### BRIEF SUMMARY OF THE INVENTION

Accordingly there is provided in a gear train having a first gear, a second gear in mesh with the first gear, and a third gear in mesh with the second gear, an anti-backlash mechanism comprising a first anti-backlash gear positioned in operative relationship with the first gear and the second gear, a second anti-backlash gear positioned in operative relationship with the second gear and the third gear, whereby the first anti-backlash gear controls backlash between the first gear and the second gear, and the second anti-backlash gear controls backlash between the second gear and the third gear.

Additionally there is provided, in a gear train having a first gear, a second gear in mesh with the first gear, and a third gear in mesh with the second gear, a method for reducing backlash comprising providing a first anti-backlash gear positioned in operative relationship with the first gear and the second gear, and providing a second anti-backlash gear positioned in operative relationship with the second gear and the third gear, whereby the first anti-backlash gear controls backlash between the first gear and the second gear, and the second anti-backlash gear controls backlash between the second gear and the third gear.

### BRIEF DESCRIPTION OF THE DRAWINGS

The present invention will hereinafter be described in conjunction with the appended drawing figures, wherein like numerals denote like elements, and:

FIG. 1 is a schematic representation of a gear train consisting of an anti-backlash gear set engaging two meshes;

FIG. 2 is a side view of the gear train of FIG. 1;

FIG. 3 is an exploded view of the antibacklash gear set in conjunction with a gear of FIG. 2.

FIG. 4 is a cut-away view of an epicyclic gear train having two anti-backlash gears and two gears sharing a common gear.

### DETAILED DESCRIPTION OF THE DRAWINGS

The following detailed description of a preferred embodiment is merely exemplary in nature and is not intended to limit the invention or the application and uses of the invention.

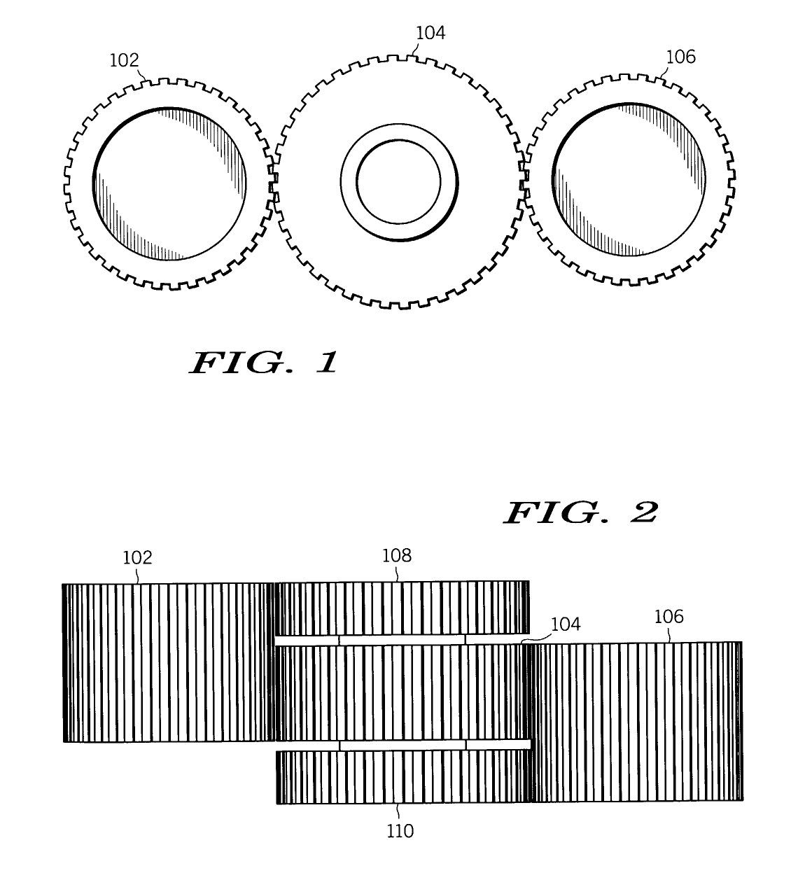

FIG. 1 is a top view of a gear train having multiple meshes, in this case two. A first gear 102, which may or may not be a pinion gear, meshes with a second gear 104, that, in turn, meshes with a third gear 106. This particular gear train is only representative, of course, and can have many different orientations and gears of different sizes as will become apparent in this description of the invention. In the past, the only viable method for eliminating backlash between both gears 102 and 104 and 104 and 106 was to have antibacklash gears on the same axes as gears 102 and 106. If a conventional antibacklash gear were coupled to gear 104, the biasing of the antibacklash gear with gear 104 would eliminate the backlash between gear 104 and one of the two other gears 102 or 106, but not both. This is unacceptable in gear trains in which high precision is required.

FIG. 2 is a side view of the gear train of FIG. 1, showing the relationship among the gears 102, 104, and 106, and also showing two anti-backlash gears 108 and 110 arranged in accordance with one embodiment of the instant invention. As may be seen in FIG. 2, two antibacklash gears 108 and 110 are coupled to the second gear 104 of the gear train of FIG. 1. Antibacklash gear 108 is coupled to second gear 104 and is preloaded by the displacement of a spring element mechanism, as will be discussed below, such that both antibacklash gear 108 and second gear 104 mesh with first gear 102. Likewise antibacklash gear 110 is coupled to second gear 104 and is preloaded by the displacement of a spring element mechanism such that both antibacklash gear 110 and second gear 104 mesh with third gear 106. As may be seen in FIG. 2, first gear 102 and third gear 106 are offset from each other, such that second gear 104 and antibacklash gear 108 may mesh with first gear 102, and antibacklash gear 110 and second gear 104 may mesh with third gear 106, but antibacklash gear 108 does not mesh with third gear 106 nor does antibacklash gear 110 mesh with first gear 102.

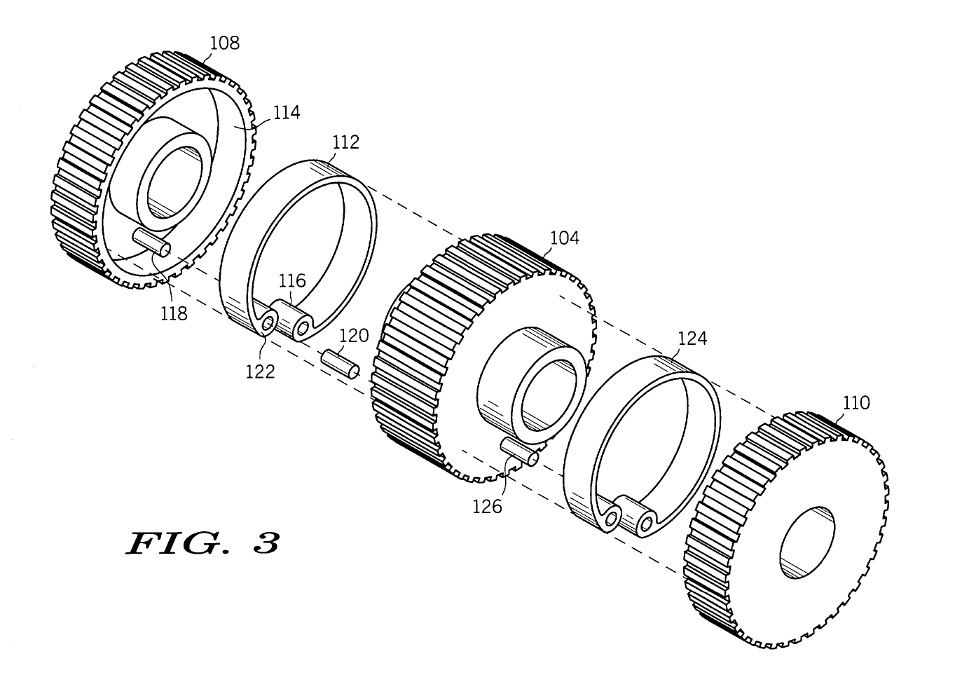

FIG. 3 is an exploded view of the antibacklash gears 108 and 110 in conjunction with the second gear 104 of FIG. 2 that shows how the antibacklash gears 108 and 110 are coupled to the second gear 104, together with the spring element for applying a load which results in a torque between the antibacklash gears and the second gear. The mechanism shown here is an internal spring 112, but other conventionally known preloading mechanisms can be used. Antibacklash gears 108 and 110 each have a recess 114 (not visible on gear 110) into which spring 112 is placed. One end of the spring 116 is attached to a pin 118 on the antibacklash gear 108. Second gear 104 likewise has a pin 120 (which is affixed to gear 104, but here is shown in exploded view) onto which the other end 122 of spring 112 is attached when the gears are assembled. The pins 118 and 120 are spaced such that after assembly the gears can be rotated in opposite directions to obtain preload torque on the antibacklash gear 108 with respect to second gear 104. Similarly, antibacklash gear 110 has associated with it another spring 124 that attaches to a pin 126 on gear 104. Another pin, not visible in this figure attaches the spring to antibacklash gear 110, and gear 110 is assembled to second gear 104 in a manner similar to the attachment of antibacklash gear 108 to second gear 104.

During assembly of the gear train of FIG. 2, antibacklash gear 108 is rotated with respect to second gear 104 to preload the spring 112. The gear pair 104, 108 is then placed in mesh with the first gear 102 such that a tooth of gear 102 is simultaneously in mesh with gears 108 and 104. The torque provided by the spring 112 will maintain the teeth of antibacklash gear 108 in contact with a tooth of first gear 102, and the torque likewise will maintain the teeth of second gear 104 in contact with the tooth of first gear 102. Thus regardless of the direction of driving torque on second gear 104, either the teeth of antibacklash gear 108 or second gear 104 will maintain contact so as to eliminate backlash from the system unless the input torque of the geartrain exceeds the preload torque of the antibacklash gear.

Thus in the embodiment of FIG. 2, the second gear is the common rotational axis for the antibacklash gears of both gear meshes, i.e., that of gears 102 and 104, and that of gears 104 and 106. As previously mentioned in conjunction with FIG. 2, gears 102 and 106 are offset from each other so that antibacklash gear 108 and gear 104 mesh only with first gear 102, and antibacklash gear 110 and second gear 104 only mesh with third gear 106.

The amount of preload torque applied to the gears is a result of gear train functional performance requirements and operation without backlash in the system. The spring torque obtained during assembly of the gear train must always be greater than the torque applied to the drive gear and the output gear in order to maintain contact between the teeth of gear 102 or 106 and the second gear 104 such that backlash is eliminated from the system.

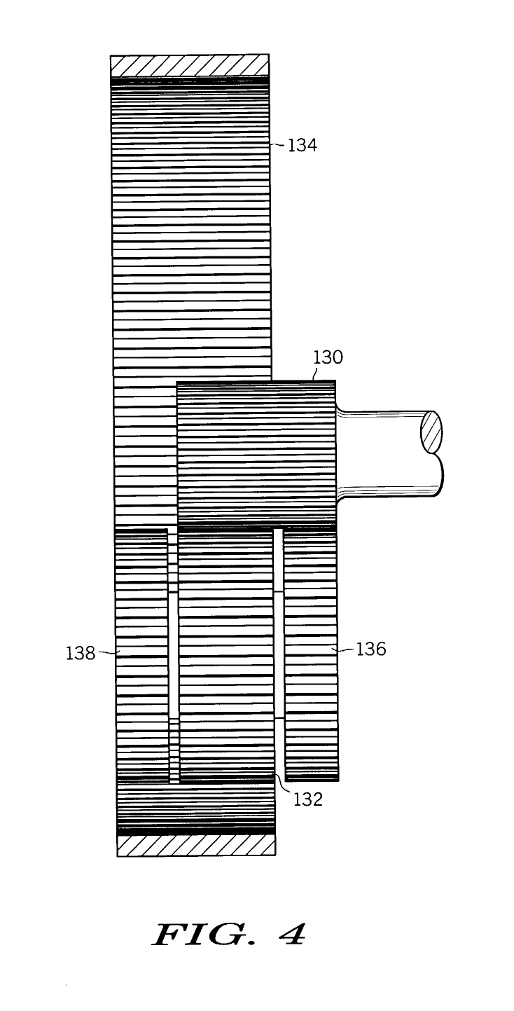

FIG. 4 shows another embodiment of the invention utilizing a planet and internal ring gear configuration of a gear train having two meshes with a common gear. This is similar to FIG. 2, with an addition of an internal gear mesh. FIG. 4 is a cut-away view of the gear train having a pinion gear 130. Meshing with the pinion gear 130 is a planet gear 132, which, in turn, meshes with an internal ring gear 134. A first antibacklash gear 136 is in mesh with the pinion gear 130, and a second antibacklash gear 138 meshes with the internal ring gear 134.

The antibacklash gears 136 and 138 are mechanically coupled to the planet gear 132 by means of springs as previously described but not visible in FIG. 4. As in the previously described embodiment of FIG. 2, the internal ring gear 134 and pinion gear 130 are offset from each other so that the planet gear 132 and the first antibacklash gear 136 can both mesh with the pinion gear 130, and the planet gear and the second antibacklash gear 138 can both mesh with the ring gear 134. This allows antibacklash gear 136 in its torque relationship with planet gear 132 to maintain the teeth of the antibacklash gear 136 and the teeth of planet gear 132 to be in constant contact with pinion gear 130, thus removing any backlash in the pinion to planet mesh.

Likewise, antibacklash gear 138 in its torque relationship with planet gear 132 is allowed to maintain the teeth of the antibacklash gear 138 and the teeth of planet gear 132 to be in constant contact with ring gear 134, thus removing any backlash in the planet to internal ring gear mesh. The embodiment of FIG. 4 can be used with any number of gear meshes.

From the foregoing detailed description of preferred exemplary embodiments, it should be appreciated that apparatus and methods are provided for removing backlash from a gear train having more than one mesh. In fact, while embodiments have been shown for gear trains of two meshes, it should be appreciated that any practical even number of meshes can be accommodated with the embodiment of the instant invention as shown in FIG. 2. For an odd number of meshes one would use this invention in combination with conventional techniques. Other variations of the invention presented here will also occur to those skilled in the art.

It should also be appreciated that these preferred embodiments are only examples, and are not intended to limit the scope, applicability, or configuration of the invention in any way. Rather, the ensuing detailed description will provide those skilled in the art with a convenient road map for implementing a preferred embodiment of the invention. It being understood that various changes may be made in the function and arrangement of elements described in an exemplary preferred embodiment without departing from the spirit and scope of the invention as set forth in the appended claims.

What is claimed is:

1. In a gear train having a first gear, a second gear in mesh with the first gear, a third gear in mesh with the second gear, an anti-backlash mechanism comprising:
a first anti-backlash gear positioned in operative relationship with the first gear and the second gear,
a second anti-backlash gear positioned in operative relationship with the second gear and the third gear, the first antibacklash gear and the second antibacklash gear being arranged on a common axis of rotation,
whereby the first anti-backlash gear controls backlash between the first gear and the second gear, and the second anti-backlash gear controls backlash between the second gear and the third gear.

2. An anti-backlash mechanism as set forth in claim 1 wherein the first anti-backlash gear is coupled to the second gear and is in mesh with the first gear.

3. An anti-backlash mechanism as set forth in claim 2 wherein the second anti-backlash gear is coupled to the second gear and is in mesh with the third gear.

4. An anti-backlash mechanism as set forth in claim 3 wherein the first anti-backlash gear is coupled to the second gear by a spring element to cause teeth of the second gear to contact teeth of the first gear to control backlash between the second gear and the first gear.

5. An anti-backlash mechanism as set forth in claim 4 wherein the spring element causes teeth of the first anti-backlash gear to contact the teeth of the first gear to control backlash between the second gear and the first gear.

6. An anti-backlash mechanism as set forth in claim 4 wherein the second anti-backlash gear is coupled to the second gear by a spring element to cause teeth of the second gear to contact teeth of the third gear to control backlash between the second gear and the third gear.

7. An anti-backlash mechanism as set forth in claim 6 wherein the spring element causes teeth of the second anti-backlash gear to contact the teeth of the third gear to control backlash between the second gear and the third gear.

8. In a gear train having at least two gear meshes, an anti-backlash mechanism comprising:
a ring gear, a pinion gear, and a planet gear, the planet gear meshing with both the ring gear and the pinion gear,
a first anti-backlash gear coupled to the planet gear and positioned to mesh with the pinion gear, a second anti-backlash gear coupled to the planet gear and positioned to mesh with the ring gear, whereby the first anti-backlash gear controls backlash between the planet gear and the pinion gear, and the second anti-backlash gear controls backlash between the planet gear and the ring gear.

9. A gear train as set forth in claim 8 wherein the first anti-backlash gear is coupled to the planet gear by a spring mechanism to cause teeth of the planet gear to contact teeth of the pinion gear to control backlash between the planet gear and the pinion gear.

10. A gear train as set forth in claim 9 wherein the spring mechanism causes teeth of the first anti-backlash gear to contact the teeth of the pinion gear to control backlash between the planet gear and the pinion gear.

11. An anti-backlash mechanism as set forth in claim 10 wherein the second anti-backlash gear is coupled to the planet gear by a spring mechanism to cause teeth of the planet gear to contact teeth of the ring gear to control backlash between the planet gear and the ring gear.

12. An anti-backlash mechanism as set forth in claim 11 wherein the spring mechanism causes teeth of the second anti-backlash gear to contact the teeth of the ring gear to control backlash between the planet gear and the ring gear.

13. In a gear train having a ring gear, a pinion gear, and a planet gear, the planet gear meshing with both the ring gear and the pinion gear, an anti-backlash mechanism comprising:
a first anti-backlash gear coupled to the planet gear and positioned to mesh with the pinion gear,
a second anti-backlash gear coupled to the planet gear and positioned to mesh with the ring gear,
whereby the first anti-backlash gear controls backlash between the planet gear and the pinion gear, and the second anti-backlash gear controls backlash between the planet gear and the ring gear.

14. In a gear train having a first gear, a second gear in mesh with the first gear, a third gear in mesh with the second gear, a method for reducing backlash comprising:
providing a first anti-backlash gear positioned in operative relationship with the first gear and the second gear, and
providing a second anti-backlash gear positioned in operative relationship with the second gear and the third gear, the first antibacklash gear and the second antibacklash gear being arranged on a common axis of rotation,
whereby the first anti-backlash gear controls backlash between the first gear and the second gear, and the second anti-backlash gear controls backlash between the second gear and the third gear.

15. A method as set forth in claim 14 further comprising coupling the first anti-backlash gear to the second gear and meshing the first anti-backlash gear with the first gear.

16. A method as set forth in claim 15 further comprising coupling the second anti-backlash gear to the second gear and meshing the second anti-backlash gear with the third gear.

17. A method as set forth in claim 16 further comprising coupling the first anti-backlash gear to the second gear by a spring mechanism to cause teeth of the second gear to contact teeth of the first gear to control backlash between the second gear and the pinion gear.

18. A method as set forth in claim 17 wherein the spring mechanism causes teeth of the first anti-backlash gear to contact the teeth of the first gear to control backlash between the second gear and the first gear.

19. A method as set forth in claim 18 further comprising coupling the second anti-backlash gear to the second gear by a spring mechanism to cause teeth of the second gear to contact teeth of the third gear to control backlash between the second gear and the third gear.

20. A method as set forth in claim 19 wherein the spring mechanism causes teeth of the second anti-backlash gear to contact the teeth of the third gear to control backlash between the second gear and the third gear.

21. In a gear train having a ring gear, a pinion gear, and a plurality of planet gears, the planet gears meshing with both the ring gear and the pinion gear, an anti-backlash mechanism comprising:
a first anti-backlash gear coupled to the pinion gear and positioned to mesh with a first planet gear,
a second anti-backlash gear coupled to the pinion gear and positioned to mesh with a second planet gear,
a third anti-backlash gear coupled to the pinion gear and positioned to mesh with the ring gear,
whereby the first anti-backlash gear controls backlash between the first planet gear and the pinion gear, the second anti-backlash gear controls backlash between the second planet gear and the ring gear, and the third antibacklash gear controls backlash between the pinion gear and the ring gear.
